(19) United States
(12) Patent Application Publication
(10) Pub. No.: US 2011/0153875 A1
(43) Pub. Date: Jun. 23, 2011

(54) OPPORTUNISTIC DMA HEADER INSERTION

(75) Inventors: Samir KHERICHA, Milpitas, CA (US); Jeffrey Michael DODSON, Portland, OR (US)

(73) Assignee: PLX Technology, Inc., Sunnyvale, CA (US)

(21) Appl. No.: 12/642,629

(22) Filed: Dec. 18, 2009

(51) Int. Cl. G06F 13/28

(52) U.S. Cl. 710/22; 710/23; 710/313

(57) ABSTRACT

In a first embodiment of the present invention, a method for operating an I/O interconnect midpoint device is presented, wherein the midpoint device has a direct memory access (DMA) controller and a plurality of ports, the method comprising: generating, using the DMA controller, a DMA read request; sending, using the DMA controller, the DMA read request to a first device connected to a first of the plurality of ports; receiving data responsive to the DMA read request from the first device; generating, using the DMA controller, a DMA write request including the received data; and sending, using the DMA controller, the DMA write request to a second device connected to the second of the plurality of ports.

### BACKGROUND OF THE INVENTION

1. Field of the Invention

The present invention relates generally to computer devices. More specifically, the present invention relates to opportunistic insertion of direct memory access (DMA) headers into existing multi-port traffic to use existing switch resources.

2. Description of the Related Art

There are many different computer Input/Output (I/O) interconnect standards available. One of the most popular over the years has been the Peripheral Component Interconnect (PCI) standard. PCI allows a bus to act like a bridge, which isolates a local processor bus from the peripherals, allowing a Central Processing Unit (CPU) of the computer to run must faster.

Recently, a successor to PCI has been popularized. Termed PCI Express (or, simply, PCIe), PCIe provides higher performance, increased flexibility and scalability for next-generation systems, while maintaining software compatibility with existing PCI applications. Compared to legacy PCI, the PCI Express protocol is considerably more complex, with three layers—the transaction, data link and physical layers.

In a PCI Express system, a root complex device connects the processor and memory subsystem to the PCI Express midpoint device fabric comprised of zero or more midpoint devices. In PCI Express, a point-to-point architecture is used. Similar to a host bridge in a PCI system, the root complex generates transaction requests on behalf of the processor, which is interconnected through a local I/O interconnect. Root complex functionality may be implemented as a discrete device, or may be integrated with the processor. A root complex may contain more than one PCI Express port and multiple midpoint devices can be connected to ports on the root complex or cascaded.

A PCIe switch is designed to forward packets received on one port of the switch to another port of the switch. A PCIe switch is not designed to generate packets, merely to forward the packets generated by other devices.

### SUMMARY OF THE INVENTION

In a first embodiment of the present invention, a method for operating an Input/Output (I/O) interconnect midpoint device is presented, wherein the midpoint device has a direct memory access controller (DMAC) and a plurality of ports, the method comprising: generating, using the DMA controller, a DMA read request; sending, using the DMA controller, the DMA read request to a first device connected to a first of the plurality of ports; receiving data responsive to the DMA read request from the first device; generating, using the DMA controller, a DMA write request including the received data; and sending, using the DMA controller, the DMA write request to a second device connected to the second of the plurality of ports.

In a second embodiment of the present invention, a method for running DMA on an I/O interconnect midpoint device is presented, wherein the midpoint device has a DMA controller, a header memory, a payload memory, and a plurality of ports, the method comprising: generating, using the DMA controller, a DMA read request; sending, using the DMA controller, the DMA read request to a first device connected to a first of the plurality of ports; receiving data responsive to the DMA read request from the first device, wherein the data includes a completion header and a payload; placing the completion header in the header memory; placing the payload in the payload memory; generating, using the DMA controller, a DMA write request header; replacing the completion header in the header memory with the DMA write request header; and sending, using the DMA controller, the DMA write request header and the payload to a second device connected to the second of the plurality of ports.

In a third embodiment of the present invention, an I/O interconnect midpoint device is provided, comprising: a main processor configured to process non-DMA related I/O interconnect communications; a plurality of ports; header memory; payload memory; and a DMA controller configured to: generate a DMA read request; send the DMA read request to a first device connected to a first of the plurality of ports; receive data responsive to the DMA read request from the first device; generate a DMA write request including the received data; and send the DMA write request to a second device connected to the second of the plurality of ports.

In a fourth embodiment of the present invention, an apparatus for operating an I/O interconnect midpoint device is provided, wherein the midpoint device has a main processor, a DMA controller, and a plurality of ports, the apparatus comprising: means for generating a DMA read request; means for sending the DMA read request to a first device connected to a first of the plurality of ports; means for receiving data responsive to the DMA read request from the first device; means for generating a DMA write request including the received data; and means for sending the DMA write request to a second device connected to the second of the plurality of ports.

In a fifth embodiment of the present invention, a program storage device readable by a machine tangibly embodying a program of instructions executable by the machine to perform a method for running DMA on an I/O interconnect midpoint device is provided, wherein the midpoint device has a main processor, a DMA controller, a header memory, a payload memory, and a plurality of ports, the method comprising: generating, using the DMA controller, a DMA read request; sending, using the DMA controller, the DMA read request to a first device connected to a first of the plurality of ports; receiving data responsive to the DMA read request from the first device, wherein the data includes a completion header and a payload; placing the completion header in the header memory; placing the payload in the payload memory; generating, using the DMA controller, a DMA write request header; replacing the completion header in the header memory with the DMA write request header; and sending, using the DMA controller, the DMA write request header and the payload to a second device connected to the second of the plurality of ports.

### BRIEF DESCRIPTION OF THE DRAWINGS

FIG. 1 is diagram illustrating a peripheral component interconnect Express (PCIe) switch in accordance with an embodiment of the present invention.

FIG. 2 is a flow diagram illustrating a method for performing DMA in a PCIe switch in accordance with an embodiment of the present invention.

FIG. 3 is a diagram illustrating a typical 4 DW memory write header.

FIG. 4 is a diagram illustrating a memory write header after it has been converted from 4 DW to 3 DW by the embodiment of the present invention described in FIG. 4.

FIG. 5 is a diagram depicting a PCIe switch having a header RAM containing only non-DMA related packet headers in accordance with an embodiment of the present invention.

FIG. 6 is a diagram depicting another state of a PCIe switch in accordance with an embodiment of the present invention.

FIG. 7 is a diagram depicting another state of a PCIe switch in accordance with an embodiment of the present invention.

FIG. 8 is a flow diagram illustrating a method for operating an I/O interconnect midpoint device in accordance with an embodiment of the present invention.

FIG. 9 is a flow diagram illustrating a method for running DMA on an I/O interconnect midpoint device in accordance with another embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, DMA is integrated within a PCIe switch in order to improve efficiency. DMA is a feature of modern computers and microprocessors that allows certain hardware subsystems within the computer to access system memory for reading and/or writing independently of the central processing unit. DMA is also used for intra-chip data transfer in multi-core processors, especially in multiprocessor system-on-chips, where its processing element is equipped with a local memory (often called scratchpad memory) and DMA is used for transferring data between the local memory and the main memory. Computers that have DMA channels can transfer data to and from devices with much less CPU overhead than computers without a DMA channel. Similarly a processing element inside a multi-core processor can transfer data to and from its local memory without occupying its processor time and allowing computation and data transfer concurrency. In other words, DMA allows for memory reads and writes without utilizing processor time, or at least minimizing processing time.

By utilizing DMA on a PCIe switch, the processor of the PCIe switch is freed up from handling the reads and writes, thus making the switch much more efficient at processing traffic. This may be implemented by using a DMA controller integrated within the chip. There are many different possible embodiments for such a DMA controller. In one embodiment, the main processor is actually part of a multi-core processor having a secondary processor that acts as a DMA controller. In another embodiment, the DMA controller may include a distinct processor that is built into the switch. In yet another embodiment, the DMA controller may be added to the switch as a module. The DMA controller may also include both hardware and software elements.

PCIe implements split transactions (transactions with request and response separated by time), allowing the link to carry other traffic while the target device gathers data for the response. The present invention extends this split transaction functionality to DMA read and write packets as well, where DMA completion packets can be added to switch memory where non-DMA traffic resides.

PCIe has separate credits for the header of a packet from the payload of the packet. In one embodiment of the present invention, this can be implemented on a PCIe switch as different physical RAMs. Other embodiments are possible as well, where other types of memory storage are utilized, or where one or the other memory are located outside the PCIe switch. However, in this document, it will be assumed that the memories are (at least virtually, if not also physically) distinct RAMs. Logically, the data may be stored in the RAMs as linked lists.

It should be noted that while the inventions described in this document are discussed in relation to the PCIe protocol, nothing in this document shall be construed as limiting the invention to the PCIe protocol unless expressly indicated. The inventions may be applied to other computer I/O interconnects unrelated to PCIe.

It should be noted that throughout this document, the term “midpoint device” is used. This term is meant to refer to a device located between two PCIe endpoints. One common example of a midpoint device is a switch. However, nothing in this document shall be construed as limiting the embodiments to only switches, absent express language to the contrary. Additionally, the midpoint device may be located anywhere between the two endpoints. It is not necessary that the midpoint device be located at or near any geographical or logical midpoint between the endpoints, only that it be logically located somewhere between the two endpoints. Indeed, embodiments are even possible where the midpoint device is located on the same physical device as one of the endpoints.

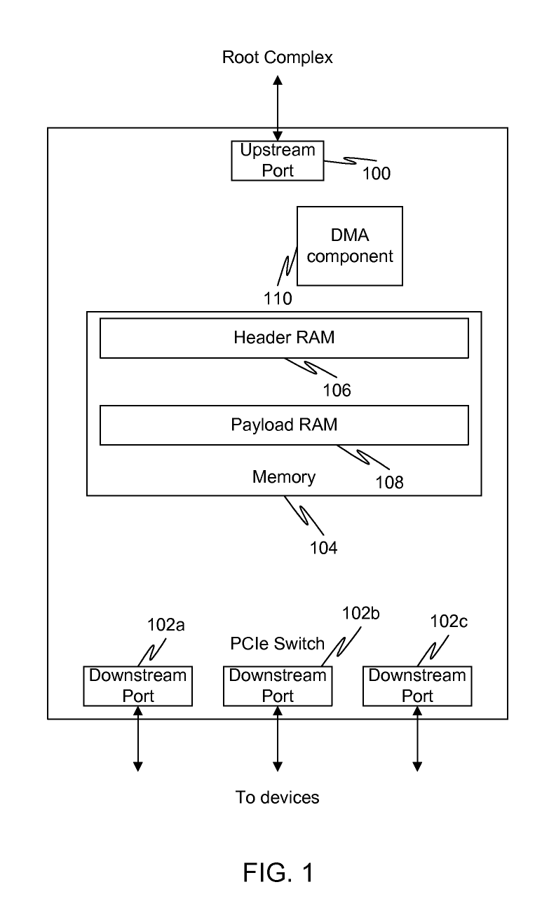

FIG. 1 is a diagram illustrating a PCIe switch in accordance with an embodiment of the present invention. Upstream port 100 is connected to a root complex. A root complex device connects the processor and memory subsystems to the switch. The root complex may also be connected to other switches as well. Similar to a host bridge in a PCI system, the root complex generates transaction requests on behalf of a processor, which is interconnected through a local bus.

On the other end of the switch, downstream ports 102a, 102b, 102c are connected to devices (endpoints). The switch acts to process and forward communications between the endpoints and also through the root complex, using memory 104. Note that memory 104 is divided into header RAM 106 and payload RAM 108. Upon receipt of the packet, the header of the packet is placed into header RAM 106 and the payload of the packet is placed to payload RAM 108. PCIe is credit based. Each link advertises header and payload credits. The link partner then ensures it has enough credits for a Transaction Layer Packet (TLP) before sending it out.

Common PCIe traffic, however, has packets with much longer payloads than headers. The larger payloads take longer to process than the shorter headers, resulting in extra available header cycles. In an embodiment of the present invention, these extra available header cycles are utilized for DMA traffic.

In an embodiment of the present invention, a DMA controller 110 is provided that handles DMA communications without the need to utilize a processor in the root complex, freeing the processor to handle other tasks and improving efficiency. A completion header for a DMA read, received from a device, is placed in the header RAM 106 where there is available space. While the header RAM 106 is typically reserved for non-DMA related communications, utilizing the extra space within the header RAM 106 allows the PCIe switch to accommodate DMA traffic without requiring that additional memory be added. The DMA controller 110 reserves space for a DMA completion before issuing a read, in order to ensure available space.

In another embodiment of the present invention, the completion header in the header RAM is then overwritten with a memory write header, while the payload (in the payload RAM) corresponding to this header is not altered. This memory write can then be read out of the header RAM without having had utilized the processor of the switch.

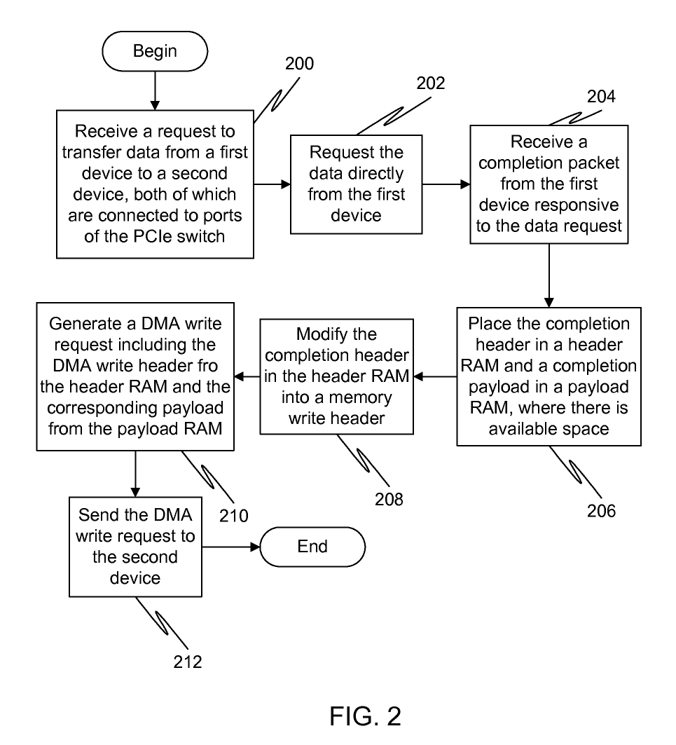

FIG. 2 is a flow diagram illustrating a method for performing DMA in a PCIe switch in accordance with an embodiment of the present invention. At 200, a DMA controller in the PCIe switch receives a request to transfer data from a first device to a second device, both of which are connected to ports of the PCIe switch. At 202, the DMA controller requests the data directly from the first device. At 204, a completion packet is received from the first device that is responsive to the data request. It contains a completion header and a completion payload. At 206, the completion header is placed in a header RAM where there is available space, and the completion payload is placed in a payload RAM, also where there is available space.

Determining where there is available space in the header RAM may occur in a variety of different ways. In an embodiment of the present invention, a credit-based flow control is used. In this scheme, header and payload credits are advertised at regular intervals. A link partner then detects the advertised credits, and only sends a TLP if there are enough header and payload credits to handle it.

At 208, the completion header in the header RAM is modified into a memory write header. There are a number of different ways this may be performed. In one embodiment of the present invention, the entire completion header is simply replaced by the memory write header. This may be fairly simple if both the completion header and the memory write header are the same size. Particularly, completion headers are typically 3 double words (DW) long, while memory write headers may be either 3 DW or 4 DW. For 3 DW memory write headers, the headers may simply be substituted for their corresponding completion headers. For 4 DW memory write headers, the issue is more complex.

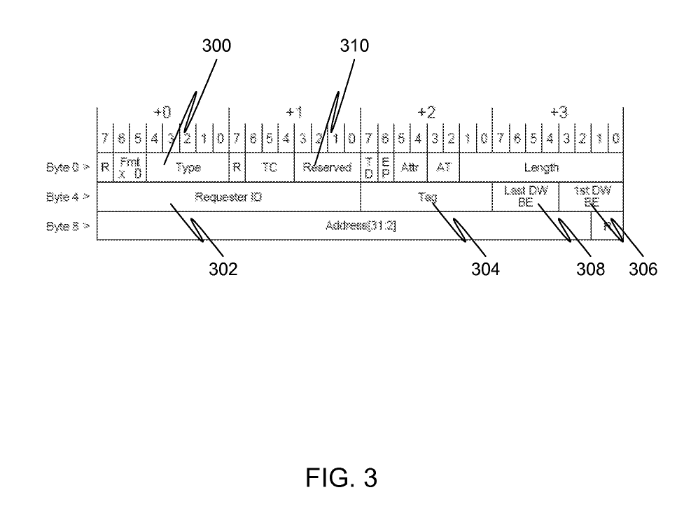

In one embodiment of the present invention, a larger memory write header is concatenated into a smaller size comparable to a completion header. This may be performed in different ways, but generally fields that aren't needed to be used are eliminated in order to shrink the overall profile of the memory write header. FIG. 3 is a diagram illustrating a typical 4 DW memory write header. What is needed is to convert this header to 3 DW. In an embodiment of the present invention, certain fields in the 4 DW header are not necessary. For example, the type 300 can be implied by the corresponding TLP in the scheduling path/control path, which indicates the header is related to a memory write. As such, there is no need for this type 300 to actually be contained in the header itself. The Requester ID 302 can be derived from the captured bus, device, and function number in the reading device. The Tag 304 isn't used for memory writes. As such, in an embodiment of the present invention, the First Byte Enable (FBE) field 306 is moved to the Type field 300 in byte 0, and the Last Byte Enable (LBE) field 308 is moved to the Reserved field 310 in byte 1. Now the entire upper 32-bit address can be stored in bytes 4 through 7 in the 3 DW entry in the header RAM.

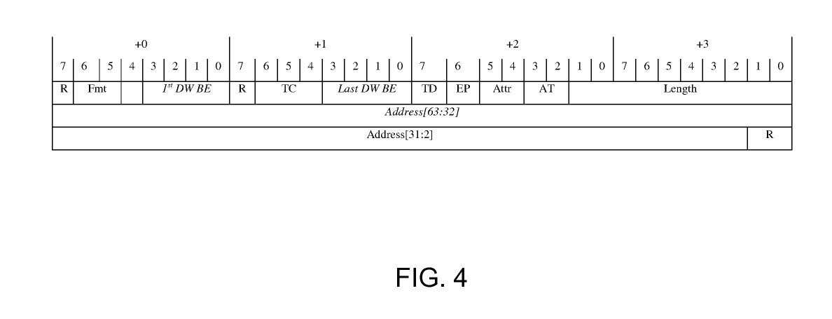

FIG. 4 is a diagram illustrating a memory write header after it has been converted from 4 DW to 3 DW by the embodiment of the present invention described above with respect to FIG. 3.

In an alternative embodiment, extra space is available surrounding the completion header, and as such a larger memory write header is simply substituted for a smaller completion header. In cases where there is no available surrounding space for such a substitution, one embodiment of the present invention involves splitting the memory write header into two and keeping track of where both parts are so that they can be reassembled later. Obviously, this requires more processing overhead than simple substitution, but may be useful where, for whatever reason, concatenation of the larger memory write header is not feasible or desired, or, for example, where in the future there may not be enough unused/reserved fields in the header.

Referring back to FIG. 2, at 210 a DMA write request including the DMA write header from the header RAM and the corresponding payload from the payload RAM is generated. At 212, the DMA write request is sent to a second device connected to the second of the plurality of ports.

It should also be noted that the functionality described above with respect to FIG. 4 may be performed using software or hardware. Specifically, dedicated circuitry or chips may be provided to implement any or all of the steps of FIG. 4. Mixtures of hardware and software may also be utilized. In one embodiment, firmware may be used to store instructions for performing various steps of FIG. 2.

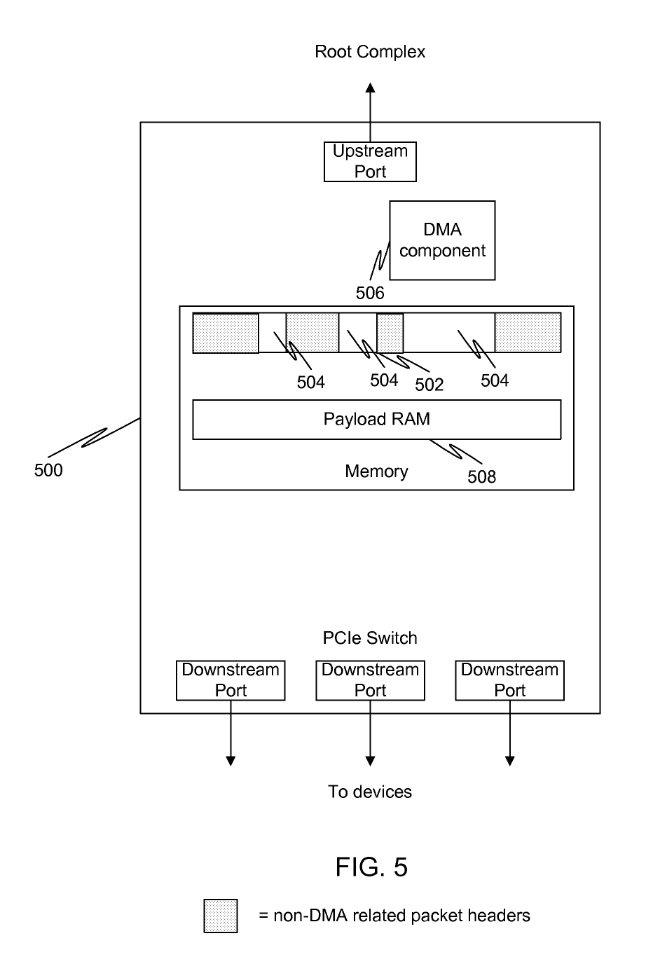

FIGS. 5-7 represent sample run-throughs of the embodiment of the present invention described above with reference to FIG. 2. Specifically, FIG. 5 depicts a PCIe switch 500 having a header RAM 502 containing only non-DMA related packet headers. As can be seen, the header RAM 502 contains areas 504 where there is available space to add additional headers. Upon receipt of a request to read data from a first device, a DMA controller 506 generates a DMA read request and sends it to the first device. A DMA read completion packet is then received. The DMA controller 506 then acts to strip off the header from the read completion packet and place it in one of the available spaces 504 in the header RAM 502. The DMA controller 506 also acts to place the payload of the DMA read completion packet in the payload RAM 508.

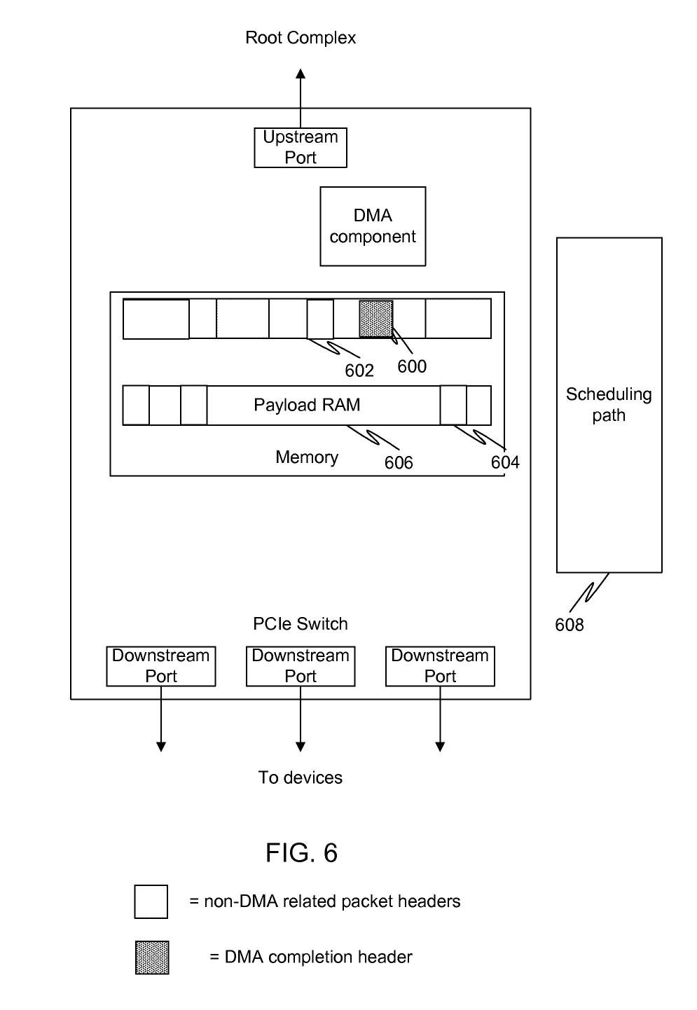

The result of this is the state of the PCIe switch depicted in FIG. 6. Namely, DMA read completion header 600 has been placed in header RAM 602, while DMA read completion payload 604 has been placed in payload RAM 606. At this point, the DMA controller replaces the DMA read completion header 600 in header RAM 602 with a newly generated DMA write request header. The DMA controller may also at this point, add a TLP corresponding to the DMA write request header to the scheduling path/control path 808 in order to get the write request on the schedule for active threads.

It should be noted that that the conversion of a completion TLP to a DMA write TLP may be performed because a DMA target port was forwarded completions for read requests made by a DMA controller inside the switch. In such cases, it would end up treating the completions as unexpected completions. Since the PCIe protocol specifies that completions/responses to a device can only be a result of a read request, and no read request was issued by the target device, the completions are treated as unexpected. A write TLP, however has no such requirement. Therefore, replacing the completion header with the write header allows the target device to accept the payload as expected.

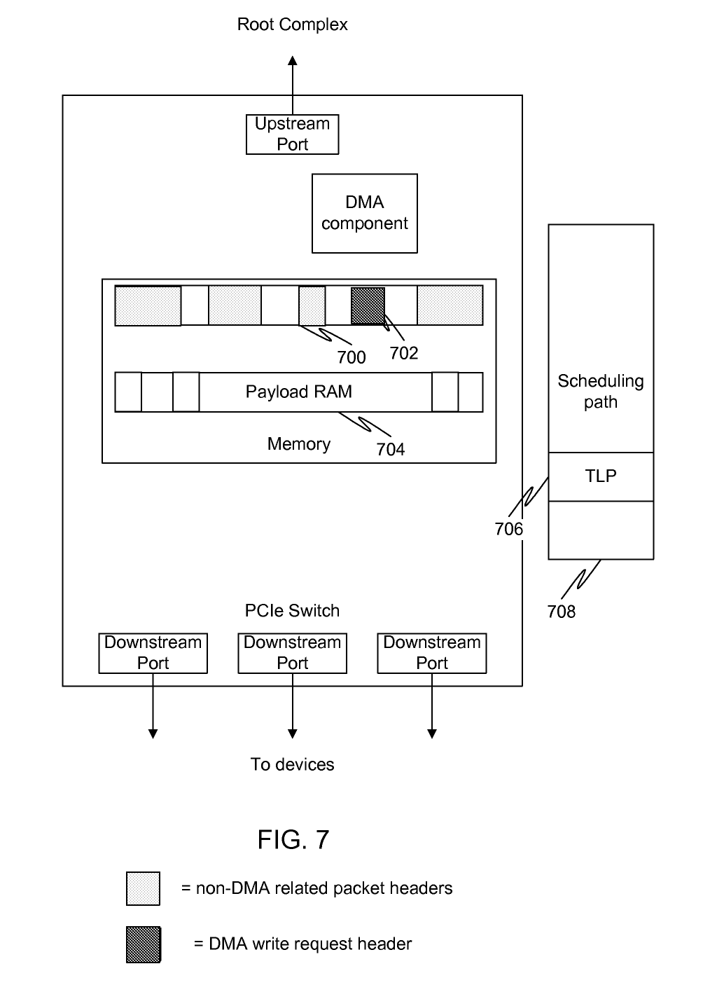

The result of this is the state of the PCIe switch depicted in FIG. 7. Namely, the DMA read completion header has been replaced in the header RAM 700 with a DMA write request header 702, while the payload RAM 704 remains unchanged. TLP 706 has been added to scheduling path/control path 708.

It should also be noted that various aspects of the present invention may be combined with each other in various permutations to arrive at additional embodiments of the present invention. For example, in one embodiment of the present invention, DMA is implemented in a PCIe switch without necessarily inserting the DMA read completion headers into a header RAM that is shared with non-DMA related packet headers. The switch may, for example, have its own dedicated RAM. It is also not necessary for this embodiment to replace the DMA read completion header in the header RAM with a newly generated DMA write request header. It may, for example simply add the newly generated DMA write request header into header RAM (or any other memory for that matter).

It should be noted that in some embodiments it is necessary for the storage to be logically separate, despite sharing the same physical memory, because PCIe usually advertises credits separately for posted/non-posted/completion.

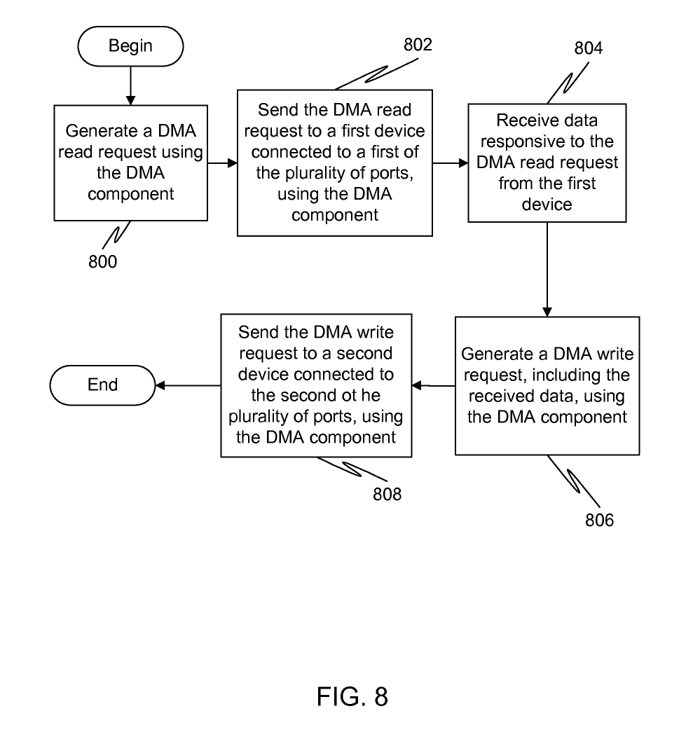

FIG. 8 is a flow diagram illustrating a method for operating an I/O interconnect midpoint device in accordance with this embodiment of the present invention. The midpoint device has a main processor, a DMA controller, and a plurality of ports, and may be, for example, a PCIe switch.

At 800, a DMA read request is generated using the DMA controller. At 802, the DMA read request is sent, using the DMA controller, to a first device connected to a first of the plurality of ports. At 804, data responsive to the DMA read request is received from the first device. At 806, a DMA write request, including the received data, is generated using the DMA controller. At 808, the DMA write request is sent, using the DMA controller, to a second device connected to the second of the plurality of ports.

It should be noted that in some embodiments the second device and the first device may be identical. This may be the case in, for example, scatter-gather applications.

In another example embodiment, DMA is implemented in a PCIe switch while inserting the DMA read completion headers into a header RAM that is shared with non-DMA related packet headers. In this embodiment, however, it is not necessary to replace the DMA read completion header in the header RAM with a newly generated DMA write request header. It may, for example simply add the newly generated DMA write request header into header RAM (or any other memory for that matter).

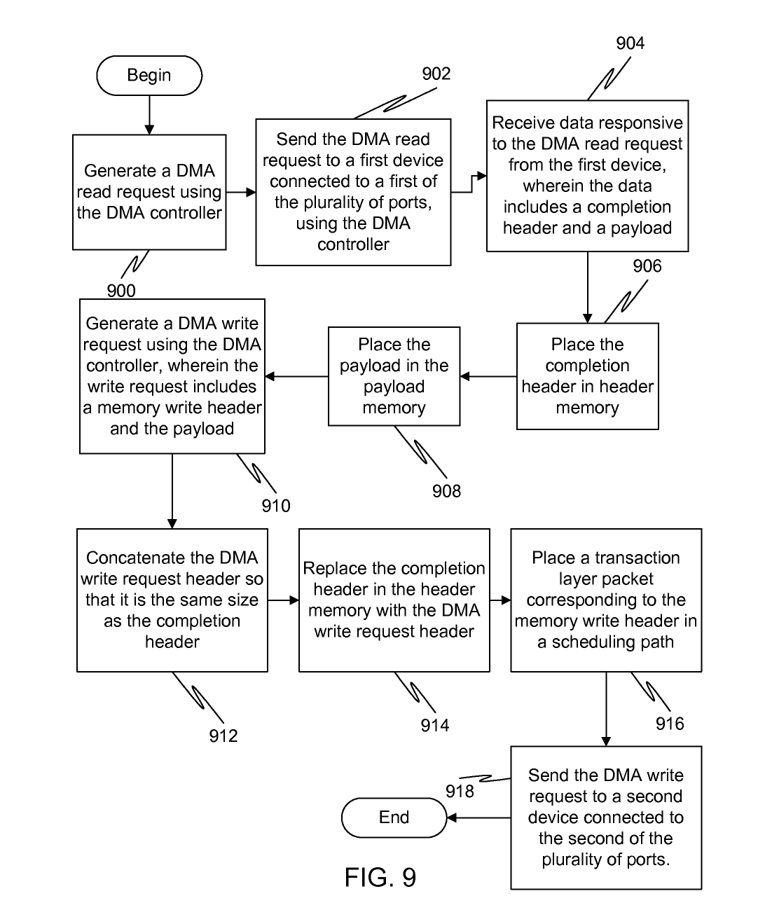

FIG. 9 is a flow diagram illustrating a method for running DMA on an I/O interconnect midpoint device in accordance with this embodiment of the present invention. The midpoint device has a main processor, a DMA controller, and a plurality of ports, and may be, for example, a PCIe switch.

At 900, a DMA read request is generated using the DMA controller. At 902 the DMA read request is sent to a first device connected to a first of the plurality of ports, using the DMA controller. At 904, data responsive to the DMA read request is received from the first device, wherein the data includes a completion header and a payload. At 906, the completion header is placed into the header memory. At 908, the payload is placed into the payload memory. At 910, a DMA write request header is generated using the DMA controller. At 912, the DMA write request header is concatenated so that it is the same size as the completion header.

At 914, the completion header in the header memory is replaced with the DMA write request header. At 916, a transaction layer packet (TLP) corresponding to the memory write header is placed in a scheduling path/control path. At 918, the DMA write request and the payload are sent to a second device connected to the second of the plurality of ports, using the DMA controller. This may occur upon the triggering of a thread generated by the TLP packet in the scheduling path/control path.

These embodiments may also be mixed and matched with each other in various combinations.

Another embodiment of the present invention is able to use interleaved completions in the header RAM. This allows the system to handle partial completions of transactions. The system may wait to receive the final partial completion in a set before considering any of the completions in that set finished.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for operating an Input/Output (I/O) interconnect midpoint device, wherein the midpoint device has a direct memory access (DMA) controller and a plurality of ports, the method comprising:
generating, using the DMA controller, a DMA read request;
sending, using the DMA controller, the DMA read request to a first device connected to a first of the plurality of ports;
receiving data responsive to the DMA read request from the first device;
generating, using the DMA controller, a DMA write request including the received data; and
sending, using the DMA controller, the DMA write request to a second device connected to the second of the plurality of ports.

2. The method of claim 1, wherein the I/O interconnect midpoint device is a Peripheral Component Interconnect Express (PCIe) switch.

3. A method for running DMA on an I/O interconnect midpoint device, wherein the midpoint device has a DMA controller, a header memory, a payload memory, and a plurality of ports, the method comprising:
generating, using the DMA controller, a DMA read request;
sending, using the DMA controller, the DMA read request to a first device connected to a first of the plurality of ports;
receiving data responsive to the DMA read request from the first device, wherein the data includes a completion header and a payload;
placing the completion header in the header memory;
placing the payload in the payload memory;
generating, using the DMA controller, a DMA write request header;
replacing the completion header in the header memory with the DMA write request header; and
sending, using the DMA controller, the DMA write request header and the payload to a second device connected to the second of the plurality of ports.

4. The method of claim 3, further comprising:
concatenating the DMA write request header so that it is the same size as the completion header.

5. The method of claim 4, wherein the concatenating includes:
deleting a type field, a requestor identification field, and a tag field in the DMA write request header.

6. The method of claim 3, wherein the concatenating further includes:
moving a first byte enable (FBE) field to the Type field and a last byte enable (LBE) to a reserved field in the DMA write request header.

7. An I/O interconnect midpoint device comprising:
a plurality of ports;
header memory;
payload memory; and
a DMA controller configured to:
generate a DMA read request;
send the DMA read request to a first device connected to a first of the plurality of ports;
receive data responsive to the DMA read request from the first device;
generate a DMA write request including the received data; and
send the DMA write request to a second device connected to the second of the plurality of ports.

8. The I/O interconnect midpoint device of claim 7, wherein the midpoint device is a PCIe switch.

9. The I/O interconnect midpoint device of claim 7, wherein the DMA write request includes a DMA write header and the payload.

10. The I/O interconnect midpoint device of claim 7, wherein the data received from the first device includes a completion header and a payload, and wherein the DMA controller is further configured to:
place the completion header in the header memory;
place the payload in the payload memory;
replace the completion header in the header memory with a newly generated DMA write request header; and
wherein the DMA write request includes the DMA write request header and the payload.

11. An apparatus for operating an I/O interconnect midpoint device, wherein the midpoint device has a main processor, a DMA controller, and a plurality of ports, the apparatus comprising:
means for generating a DMA read request;
means for sending the DMA read request to a first device connected to a first of the plurality of ports;
means for receiving data responsive to the DMA read request from the first device;
means for generating a DMA write request including the received data; and
means for sending the DMA write request to a second device connected to the second of the plurality of ports.

12. The apparatus of claim 11, wherein the I/O interconnect midpoint device is a Peripheral Component Interconnect Express (PCIe) switch.

13. The apparatus of claim 11, further comprising:
means for concatenating the DMA write request header so that it is the same size as the completion header.

14. The apparatus of claim 13, wherein the means for concatenating includes:
means for deleting a type field, a requestor identification field, and a tag field in the DMA write request header.

15. The apparatus of claim 13, wherein the means for concatenating further includes:
means for moving a first byte enable (FBE) field to the Type field and a last byte enable (LBE) to a reserved field in the DMA write request header.

16. A program storage device readable by a machine tangibly embodying a program of instructions executable by the machine to perform a method for running DMA on an I/O interconnect midpoint device, wherein the midpoint device has a main processor, a DMA controller, a header memory, a payload memory, and a plurality of ports, the method comprising:
generating, using the DMA controller, a DMA read request;
sending, using the DMA controller, the DMA read request to a first device connected to a first of the plurality of ports;
receiving data responsive to the DMA read request from the first device, wherein the data includes a completion header and a payload;
placing the completion header in the header memory;
placing the payload in the payload memory;
generating, using the DMA controller, a DMA write request header;
replacing the completion header in the header memory with the DMA write request header; and
sending, using the DMA controller, the DMA write request header and the payload to a second device connected to the second of the plurality of ports.
